(19) United States
(12) Patent Application Publication
(10) Pub. No.: US 2017/0061467 A1
(43) Pub. Date: Mar. 2, 2017

(54) MITIGATING BIAS IN LIFT ANALYSIS FOR DEMAND SIDE PLATFORMS

(71) Applicant: Facebook, Inc., Menlo Park, CA (US)

(72) Inventors: Jason George McHugh, Seattle, WA (US); Emile Vladimir Litvak, San Francisco, CA (US)

(21) Appl. No.: 14/839,879

(22) Filed: Aug. 28, 2015

(51) Int. Cl. G06Q 30/02

(52) U.S. Cl. CPC G06Q 30/0242

(57) ABSTRACT

A demand side platform (DSP) performs lift analysis on one or more advertisements provided by an entity to determine how effective the one or more advertisements cause users to perform various actions. To reduce bias in the lift analysis, when the DSP identifies an opportunity to present an advertisement to a user, the DSP identifies candidate advertisements for presentation to the user and selects a candidate advertisement. If the candidate advertisement is undergoing lift analysis and the user is in a holdout group that is not presented with the candidate advertisement, the DSP selects an alternative advertisement and associates a bid amount for the selected advertisement with the alternative advertisement. If the alternative advertisement is presented to the user, the DSP may allocate an amount charged between an entity associated with the alternative advertisement and an entity associated with the selected advertisement.

### BACKGROUND

This disclosure relates generally to presentation of sponsored content, and more specifically to mitigating bias in holdout groups for demand side platforms (DSPs).

Demand side platforms (DSPs) allow entities to automate sponsorship of content presented by various online systems. A DSP receives one or more sponsored content items from an entity along with targeting criteria associated with various sponsored content items. Targeting criteria associated with a sponsored content item identifies characteristics of users eligible to be presented with the sponsored content items. For example, a user having characteristics satisfying at least a threshold number of targeting criteria associated with a sponsored content item is eligible to be presented with the sponsored content item. The DSP then automatically purchases impressions of sponsored content items (i.e., presentation of advertisements to users) from an online system that provides content to users based on the targeting criteria of the sponsored content items. A DSP may purchase impressions from an online system presenting content through a real-time auction in which various DSPs or other content providers provide bid amounts to the online system as content from the online system is being presented to a user. The combination of DSPs and real-time auctions allow entities to more effectively present sponsored content items to various users while lowering costs to the entity for presenting sponsored content items.

Typically, DSPs and entities purchase impressions of sponsored content items from an exchange or a supply side platform (SSP). An online system presenting content may set minimum prices, inventory counts, and other conditions for purchasing impression via the online system on the SSP. A SSP manages a large number of impressions and communicates with DSPs to maximize revenue provided to online systems presenting sponsored content items along with content while minimizing overhead costs for these online systems.

Additionally, an entity providing sponsored content items that are presented by one or more online systems may seek to determine the effectiveness of the sponsored content items presented to users. For example, the entity identifies one or more actions it desires users to perform after being presented with a sponsored content item. When a user presented with the sponsored content item performs one of the identified actions, a conversion is identified. Hence, an entity may seek to determine a conversion rate for a sponsored content item that measures the number of identified actions associated with the sponsored content item that have been performed by users presented with the sponsored content item. While presentation of a sponsored content item to a user may cause the user to perform an action identified by the entity providing the sponsored content item, the user may also have naturally performed the action without being influenced by the sponsored content item. Hence, the entity may perform a lift analysis of an action performed by the user to determine whether presentation of a sponsored content item to the user caused the user to perform the action. This allows an entity to determine whether sponsored content item provided by the user are effective in obtaining revenue for the entity. However, while a DSP may perform lift analysis on sponsored content items for an entity, implementing lift analysis by the DSP may introduce bias during a process for selecting sponsored content items for presentation.

### SUMMARY

An entity, such as an advertiser, provides advertisements to a demand side platform (DSP), which maintains advertisements and identifies opportunities by various online systems to present advertisements. Various advertisements received by the DSP include targeting criteria specifying characteristics of users eligible to be presented with the advertisements. For example, a user having characteristics satisfying at least a threshold number of targeting criteria associated with an advertisement is eligible to be presented with the advertisement, while another user having characteristics satisfying less than the threshold number of targeting criteria is not eligible to be presented with the advertisement. Additionally, an advertisement includes bid information describing a maximum amount of compensation an entity providing the advertisement is willing to provide as compensation for presenting the advertisement or as compensation for a user presented with the advertisement performing one or more specified actions. Bid information included in an advertisement may be specified by an entity from which the advertisement was received. For example, bid information included in an advertisement specifies different maximum amounts of compensation for presenting the advertisement to users with characteristics satisfying different numbers of targeting criteria included in the advertisement (e.g., larger amounts of compensation for presenting the advertisement to users with characteristics satisfying higher numbers or higher percentages of targeting criteria). The DSP identifies opportunities to present advertisements (“impressions”) by one or more online systems providing content based at least in part on the targeting criteria associated with advertisements received by the DSP based on targeting criteria included in the advertisements and information describing the impressions.

In some embodiments, the online system identifies an opportunity to present one or more advertisements and requests an advertisement from the DSP. Alternatively, the online system receives an identification of an opportunity to present one or more advertisements and requests an advertisement from the DSP. For example, the online system identifies an opportunity to present an advertisement in a web page provided by the online system, an opportunity to present an advertisement in video content provided by the online system, an opportunity to present an advertisement in a virtual world provided by the online system, or an opportunity to present an advertisement in any suitable content provided by the online system. The DSP receives a request for one or more advertisements from the online system identifying the opportunity identified by the online system. In some embodiments, the request for one or more advertisements includes information associated with a user to be presented with content by the online system. Example information associated with the user included in the request for one or more advertisements includes demographic information of the user, an identifier or a description of the content to be presented to the user by the online system, additional content previously presented to the user, a location associated with the user, or other suitable information.

Based on the received request for one or more advertisements and targeting criteria associated with advertisements maintained by the DSP, the DSP selects one or more candidate advertisements from the maintained advertisements. A candidate advertisement is associated with at least a threshold number of targeting criteria satisfied by characteristics of the user. For example, a candidate advertisement is associated with a location, a gender, and an age range that are each satisfied by demographic information associated with the user included in the request for one or more advertisements received by the DSP.

Using bid information included in each candidate advertisement, as well as characteristics of the user, and targeting criteria included in each candidate advertisement, the DSP computes a bid amount for each candidate advertisement. The bid amount of a candidate advertisement represents a maximum amount of compensation from an entity associated with the candidate advertisement to the online system if the candidate advertisement is presented to a user by the online system or if a user presented with the advertisement by the online system performs one or more actions associated with the advertisement by the entity. In some embodiments, the maximum amount of compensation represented by the bid amount of a candidate advertisement represents a maximum amount of compensation the DSP provides to the online system, which may differ from a maximum amount of compensation specified by the entity associated with the candidate advertisement, requesting the one or more advertisements. Bid information included in a candidate advertisement may determine the bid amount for the candidate advertisement based at least in part on a number or a percentage of targeting criteria included in the candidate advertisement satisfied by characteristics of the user.

The DSP performs one or more selection processes on the candidate advertisement based at least in part on the bid amounts of the candidate advertisements. For example, the DSP ranks the candidate advertisements based on their associated bid amounts and selects a candidate advertisement having a highest position in the ranking or having at least a threshold position in the ranking. The DSP then determines whether the selected candidate advertisement is undergoing lift analysis to determining an effectiveness of the advertisement in causing users presented with the advertisement to perform one or more actions specified by the entity providing the advertisement. To perform lift analysis on an advertisement, certain users for whom the advertisement is selected for presentation are randomly selected for inclusion in a holdout group associated with the advertisement. The advertisement is not presented to users in the holdout group, even when the advertisement is selected for presentation to the users in the holdout group. Hence, the DSP determines whether the user for whom the selected candidate advertisement was presented is included in a holdout group for the selected candidate advertisement.

In response to determining the user is included in a holdout group associated with the selected candidate advertisement, the DSP performs one or more actions to present an advertisement to the user while mitigating biases that may decrease an accuracy of the lift analysis of the selected candidate advertisement. In some embodiments, the DSP identifies a candidate advertisement having a lower position in the ranking of candidate advertisements based on their bid amounts. For example, the DSP identifies a candidate advertisement having a second highest position in the ranking. The DSP communicates the identified candidate advertisement to the online system but associates the identified candidate advertisement with the bid amount of the selected candidate advertisement, for which the user was in the holdout group. The online system uses the bid amount of the selected candidate advertisement as well as bid amounts associated with additional advertisements received by the online system from the DSP and other DSPs or entities to select an advertisement for presentation to the user via the identified opportunity. If the online system selects the identified candidate advertisement, the online system presents the identified candidate advertisement to the user. The online system may subsequently provide information identifying the user to whom the identified candidate advertisement was presented as well as actions performed by the user after being presented with the identified candidate advertisement to the DSP, allowing the DSP to subsequently determine an influence of the selected candidate advertisement in causing users presented with the selected candidate advertisement to perform actions associated with the selected candidate advertisement by the entity providing the selected candidate advertisement to the DSP. In some embodiments, the entity that provided the selected candidate advertisement to the DSP also provides information describing actions performed by the user presented with the identified candidate advertisement to the DSP.

### BRIEF DESCRIPTION OF THE DRAWINGS

FIG. 1 is a block diagram of a system environment for a demand side platform (DSP), in accordance with an embodiment.

FIG. 2 is an example block diagram of an architecture of the DSP, in accordance with an embodiment.

FIG. 3 is an interaction diagram of a method for providing advertisements to an online system for presentation to a user in a holdout group to which presentation of an advertisement is prevented, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

System Architecture

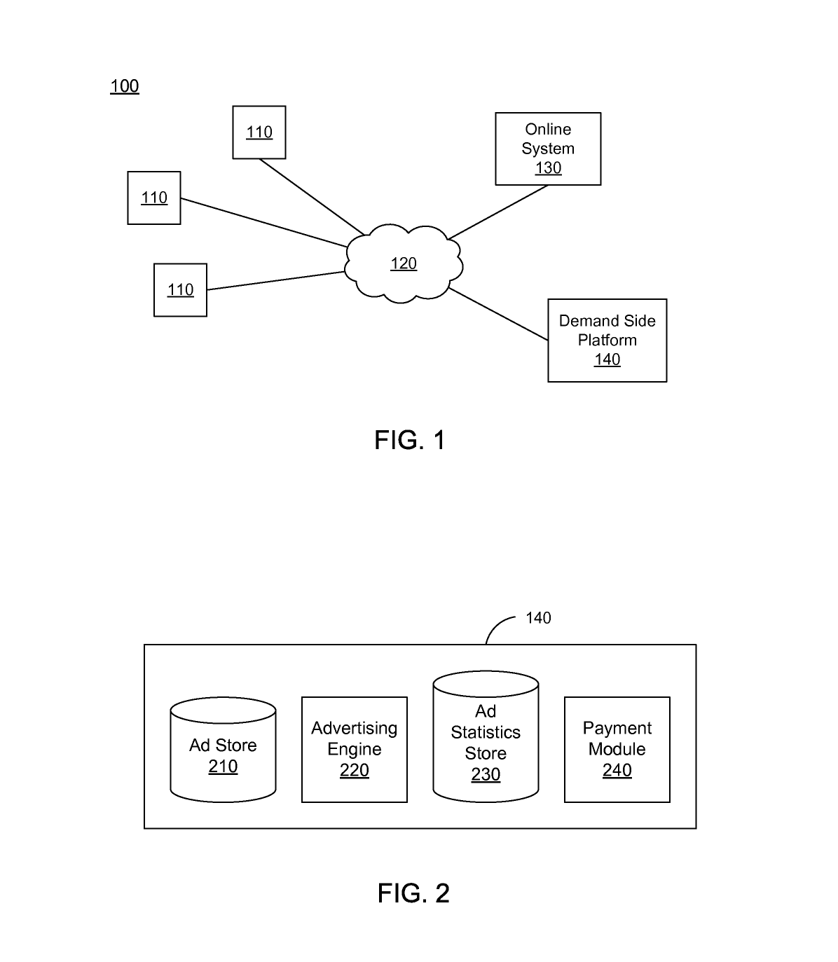

FIG. 1 is one embodiment of a block diagram of a system environment 100 for a demand side platform (DSP) 140. The system environment 100 shown by FIG. 1 comprises one or more client devices 110, a network 120, one or more online systems 130, and the DSP 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with an online system 130 or with the DSP 140. For example, a client device 110 executes a browser application to enable interaction between the client device 110 and an online system 130 via the network 120. In another embodiment, a client device 110 interacts with the online system 130 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

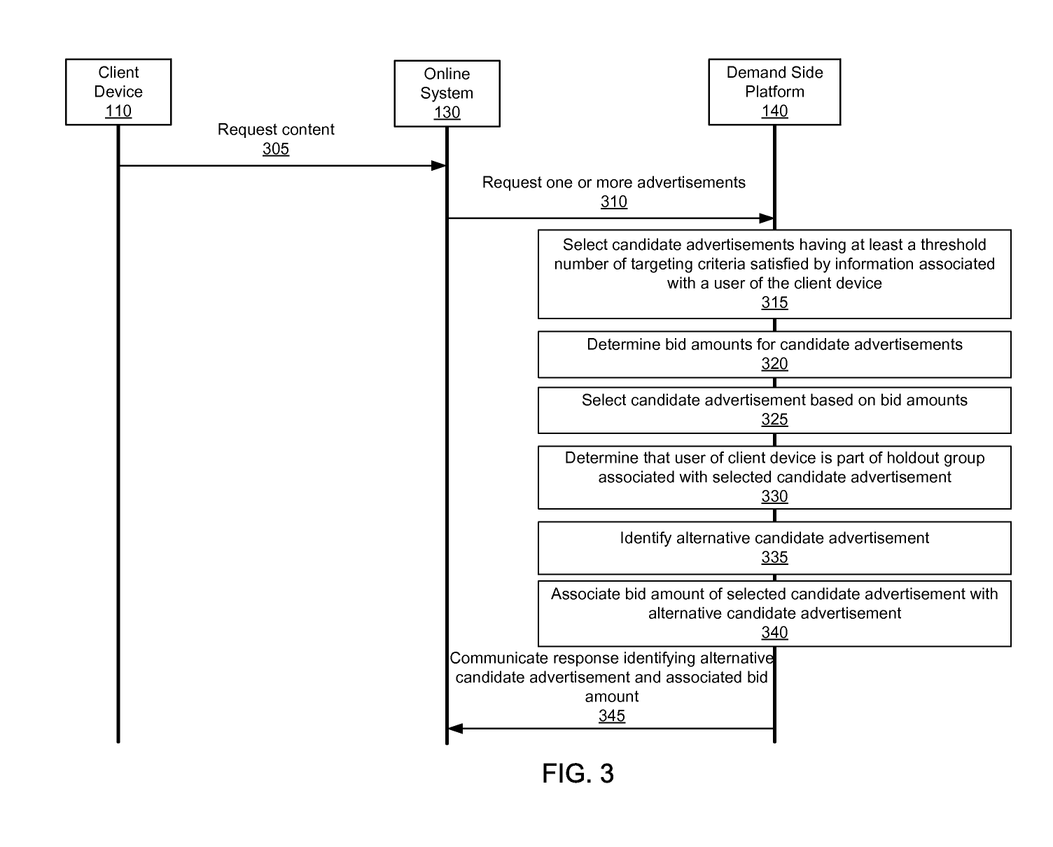

One or more online systems 130 may be coupled to the network 120 for communicating with the client devices 110 or with the DSP 140, which is further described below in conjunction with FIG. 2. An online system 130 may provide content for presentation to users via a client device 110. For example, an online system 130 provides web pages, video data, messages, a virtual world, or other suitable content to users. Content presented by an online system 130 may include opportunities for presentation of advertisements (i.e., “impressions” of advertisements), allowing entities to provide advertisements to the online system 130 for presentation along with content, as further described below in conjunction with FIG. 3.

In other embodiments, an online system 130 is a supply side platform (SSP) receiving indications from other online systems 130 of opportunities to present advertisements with content provided to users by the other online systems 130. The online system 130 communicates with the DSP 140, which is further described below in conjunction with FIG. 2, to identify advertisements for communication to the other online systems 130 for presentation. For example, an online system 130 providing a web page to a user identifies an opportunity to present an advertisement in conjunction with the web page or within the web page to another online system 130 that communicates with the DSP 140 to identify an advertisement for the online system 130 to present, as further described below in conjunction with FIG. 3.

FIG. 2 is an example block diagram of an architecture of the DSP 140. The DSP 140 shown in FIG. 2 includes an advertisement (“ad”) store 210, an advertising engine 220, an ad statistics store 230, and a payment module 240. In other embodiments, the DSP 140 may include additional, fewer, or different components than those described in conjunction with FIG. 2. Conventional components such as network interfaces, security functions, load balancers, failover servers, management and network operations consoles, and the like are not shown so as to not obscure the details of the system architecture.

The ad store 210 stores advertisements and related data. In various embodiments, advertisements in the ad store 210 are received from various online systems 140 or other entities. An advertisement includes an ad creative, targeting criteria, bid information, an identifier, and may include additional information. The identifier uniquely identifies the advertisement to the DSP 140 or to the entity that provided the advertisement to the DSP 140. The ad creative is content presented to users and may be text, image, audio, video, or any other suitable data presented to a user. One or more ad creatives may include a landing page specifying a network address to which a user is directed when the advertisement is accessed.

Targeting criteria included in an advertisement specify one or more characteristics of users eligible to be presented with the ad creative included in the advertisement. For example, targeting criteria are used to identify users having user demographic information or having performed actions satisfying at least one of the targeting criteria as eligible to be presented with an advertisement creative. An entity associated with an advertisement may specify a threshold number or percentage of targeting criteria included in an advertisement satisfied by characteristics of a user for the user to be eligible to be presented with an ad creative included in the advertisement. Hence, targeting criteria allow an advertiser or entity to identify users having specific characteristics, simplifying subsequent distribution of content to different users.

Bid information in an advertisement includes one or more bid amounts specifying monetary amounts an online system 130 receives from an entity associated with the advertisement (e.g., an advertiser) if the online system 130 presents an ad creative in the advertisement or if a user of the online system 130 presented with the ad creative performs one or more actions associated with the advertisement by the entity associated with the advertisement. In some embodiments, the bid information includes different bid amounts associated with different criteria, so a bid amount associated with at least a threshold number of satisfied criteria is selected. For example, different bid amounts are associated with different numbers or percentages of targeting criteria satisfied by characteristics of a user, so different bid amounts are selected for users with characteristics satisfying different numbers or percentages of targeting criteria. Additional criteria that may be used by the bid information to select a bid amount include: an online system 130 presenting an ad creative from the advertisement, a time of day the ad creative from the advertisement is to be presented, a location of a user to whom the ad creative from the advertisement is to be presented, or any other suitable information.

The DSP 140 allows entities associated with advertisements maintained in the ad store 210 to perform lift analysis on various advertisements. Lift analysis of an advertisement allows an entity associated with the advertisement to evaluate an effectiveness of the advertisement in causing users presented with the advertisement to perform one or more actions associated with the advertisement by the entity. Examples of actions associated with an advertisement by an entity include: accessing the advertisement, adding an item included in the advertisement to an online shopping cart, purchasing an item associated with the entity, installing an application identified by the advertisement, or other suitable actions.

In various embodiments, the DSP 140 performs lift analysis of an advertisement by identifying a holdout group of users that includes users eligible to be presented with the advertisement to whom the advertisement is not presented. When providing an advertisement to the DSP 140, an entity associated with an advertisement may specify whether to perform lift analysis on the advertisement. If the entity specifies performance of lift analysis on an advertisement, the entity provides information identifying a size of a holdout group associated with the advertisement, an amount of compensation from the entity to the DSP 140 for performing lift analysis, as well as additional information for use by the DSP 140 to perform the lift analysis.

The advertising engine 220 identifies advertisements and bid amounts to an online system 130 that has identified an opportunity to present one or more advertisements to the DSP 140 based on information in the ad store 210. In some embodiments, an online system 130 provides a request for one or more advertisements to the DSP 140 when the online system 130 identifies an opportunity to present one or more advertisements to a user of the online system 130. A request for one or more advertisements includes information describing the opportunity to present the one or more advertisements. For example, the request for one or more advertisements identifies the online system 130 and may include information associated with the user of the online system 130 associated with the opportunity to present the one or more advertisements. Information associated with the user of the online system may include: a location associated with the user, a current time, a user identifier, content previously accessed by the user, demographic information associated with the user, one or more actions performed by the user, or any other suitable information. In some embodiments, the DSP 140 stores information associated with users of the online system 140, such as users of the online system 130 associated with previously received requests for advertisements from the online system 130, allowing the DSP 140 to retrieve information associated with the user from a user identifier or other identifying information included in a request for one or more advertisements from the online system 130. For example, the DSP 140 stores information identifying content previously presented to a user of an online system 140 in association with a user identifier associated with the user by the online system 140, allowing the online system 140 to include less information associated with the user in requests for advertisements provided to the DSP 140.

In response to receiving a request for one or more advertisements from an online system 140, the advertising engine 220 compares information associated with a user identified by the received request with targeting criteria included in various advertisements in the ad store 210. The advertising engine 220 selects advertisements from the ad store 210 having at least a threshold number of targeting criteria satisfied by the information associated with the user as candidate advertisements; hence, a candidate advertisement is an advertisement eligible for presentation to the user identified by the received request. For various candidate advertisements, the advertising engine 220 determines a bid amount based on the bid information included in the various candidate advertisements. As an example, the advertising engine 220 determines a bid amount for each candidate advertisement based on bid information included in each candidate advertisement. In various embodiments, bid information included in a candidate advertisement determines a bid amount for the candidate advertisement based at least in part on a number or a percentage of targeting criteria included in the candidate advertisement that are satisfied by the information associated with the user identified in the received request.

Based at least in part on the bid amounts determined for the candidate advertisements, the advertising engine 220 selects a candidate advertisement. For example, the advertising engine 220 ranks the candidate advertisements based on their bid amounts and selects a candidate advertisement having a highest position in the ranking or having at least a threshold position in the ranking. Alternatively, the advertising engine 220 selects a candidate advertisement having a maximum bid amount. The advertising engine 220 communicates a response to the online system 140 including the selected candidate advertisement (or an identifier of the selected candidate advertisement) and its associated bid amount to the online system 130. Based at least in part on bid amounts associated with various advertisements received by the online system 130, the online system 130 applies one or more selection processes to the received advertisements to select one or more advertisements for presentation via the opportunity to present one or more advertisements. In some embodiments, the advertising engine 220 sends the response to the online system 130 within a threshold amount of time of receiving the request for one or more advertisements (e.g., within 100 ms). This allows an online system 130 to select an advertisement for presentation shortly before content presented along with the advertisement is provided to a user, allowing entities to provide advertisements for presentation by the online system in near real-time to presentation of content to a user.

When the advertising engine 220 sends a response to online system 130, the advertising engine 220 may include a tracking mechanism for presentation via the advertisement, such as a tracking pixel. The tracking mechanism comprises instructions that, when executed by a client device 110, communicate information from the client device 110 to the DSP 140. If the online system 130 selects the selected candidate advertisement identified by the DSP 140 for presentation, the online system 130 presents the selected candidate advertisement or communicates information identifying the selected candidate advertisement (e.g., a link to the selected candidate advertisement) to another online system 130 for presentation. The selected candidate advertisement is subsequently communicated to a client device 110 for presentation to the user. When the client device 110 presents the selected candidate advertisement, the client device 110 executes the tracking mechanism, the client device 110 retrieves information identified by the tracking mechanism (e.g., information identifying the user to whom the selected candidate advertisement was presented, one or more interactions by the user with the presented candidate advertisement or with content presented to the user, a location of the client device 110, parameters of the client device 110, etc.). For example, a browser executing on the client device 110 and presenting content and the selected candidate advertisement executes instructions in the selected candidate advertisement that communicate a request from the client device 110 having one or more query strings appended to the request including information describing interaction with or presentation of the selected candidate advertisement. Additional information may be communicated to the DSP 140 by the online system 130 providing the selected candidate advertisement to a client device 110 for presentation, such as an amount of compensation to request from an entity associated with the selected candidate advertisement.

The ad statistics store 230 includes information describing presentation of various advertisements maintained in the ad store 210 to users of various online systems 130. Example information included in the ad statistics store 230 includes: dates and times when various advertisements were selected by an online system 130 for presentation, identifiers of online systems 130 which presented advertisements communicated to the online systems 130 from the DSP 140, amounts charged to entities associated with advertisements presented by online systems 130, interactions with advertisements identified to online systems 130 by the DSP 140, whether interactions with an advertisement identified to an online system 130 by the DSP 140 match actions associated with the advertisement by an entity, demographic information associated with a user of an online system 130 to whom an advertisement selected by the DSP 140 was presented, and any other suitable information. The ad statistics store 230 may associate any of the preceding information, or other information, with an identifier included in an advertisement to allow subsequent analysis of presentation of the advertisement. Information included in the ad statistics module 230 may be received from various client devices 110 executing tracking mechanisms included in advertisements selected by the DSP 140.

In various embodiments, the DSP 140 includes a payment module 240, which identifies amounts of compensation to request from entities associated with various advertisements. For example, the payment module 240 identifies an amount to charge an entity associated with an advertisement that is communicated to an online system 130 because an additional advertisement is withheld from presentation. In some embodiments, if a selected candidate advertisement is undergoing lift analysis, the payment module 240 determines an amount to associate with an alternative advertisement that is communicated to an online system 130 in place of the selected candidate advertisement. Determination of amounts to charge entities associated with various advertisements evaluated by the DSP 140 is further described below in conjunction with FIG. 3.

Providing Advertisements to Users while Performing Lift Analysis on Advertisements

FIG. 3 is an interaction diagram of one embodiment of a method for providing advertisements to an online system 130 for presentation to a user in a holdout group to which presentation of an advertisement is prevented. For purposes of illustration, FIG. 3 shows an embodiment including a client device 110, an online system 130, and a demand side provider (DSP) 140. However, in other embodiments, different and/or additional devices may be included. For example, an online system 130 may communicate a request for an advertisement to another online system 130 that subsequently communicates the request to the DSP 140. Additionally, in other embodiments, steps of the method may be performed in different orders than the order described in conjunction with FIG. 3 or the method may include different and/or additional steps than those described in conjunction with FIG. 3.

A client device 110 requests 305 content from an online system 130. For example, the client device 110 requests 305 a web page, requests 305 video data, or requests 305 any suitable content from the online system 130. The requested content includes an opportunity to present one or more advertisements along with the content. For example, the requested content is a web page including one or more positions for presenting one or more advertisements. The online system 130 requests 310 one or more advertisements from the DSP 140 in response to the opportunity to present one or more advertisements with the requested content. While FIG. 3 shows an example where the online system 130 requests the one or more advertisements from the DSP 140, in other embodiments the online system 130 communicates information identifying the opportunity to present one or more advertisements to another online system 130 that requests 310 one or more advertisements from the DSP 140. In other embodiments, the online system 130 communicates the content to the client device 110, which requests 310 one or more advertisements from the DSP 140 while the client device 110 is presenting the content.

After receiving the request for one or more advertisements, the DSP 140 selects candidate advertisements from the advertisements stored by the DSP 140. As further described above in conjunction with FIG. 2, a candidate advertisement is an advertisement including at least a threshold number of targeting criteria satisfied by information associated with a user associated with the client device 110 that requested 305 content from the online system 130. In various embodiments, the online system 130 includes information associated with the user (e.g., demographic information, additional content presented to the user by the online system 130 or by the client device 110, a user identifier associated with the user by the online system 130 or by the DSP 140) in a request for one or more advertisements communicated to the DSP 140. Based on the information associated with the user included in the request, the DSP 140 selects 315 various candidate advertisements.

The DSP 140 determines 320 bid amounts for the candidate advertisements based on bid information included in the candidate advertisements. In some embodiments, the DSP 140 determines 320 a bid amount for each of the candidate advertisements. As described above in conjunction with FIG. 2, bid information in a candidate advertisement may cause the DSP 140 to determine 320 a bid amount for the candidate advertisement based at least in part on a number of targeting criteria included in the candidate advertisement satisfied by information associated with the user. For example, the candidate advertisement has a larger determined bid amount if a larger number or percentage of targeting criteria included in the candidate advertisement is satisfied by information associated with the user. Based at least in part on the determined bid amounts, the DSP 140 selects 325 a candidate advertisement. For example, the DSP 140 ranks the candidate advertisements based at least in part on their determined bid amounts and selects 325 a candidate advertisement having a highest position in the ranking or having at least a threshold position in the ranking. As another example, the DSP 140 selects 325 a candidate advertisement having a maximum bid amount.

Based on information associated with the selected candidate advertisement, the DSP 140 determines whether the selected candidate advertisement is undergoing lift analysis to evaluate an effectiveness of the selected candidate advertisement inducing users to perform actions associated with the selected candidate advertisement by an entity that provided the advertisement to the DSP 140. If the selected candidate advertisement is not undergoing lift analysis, the DSP 140 communicates the selected candidate advertisement and its bid amount to the online system 130, which applies one or more selection processes to the selected candidate advertisement and other advertisements to select an advertisement for presentation to the user associated with the client device 110 via the client device 110.

However, if the DSP 140 determines the selected candidate advertisement is undergoing lift analysis, the DSP 140 determines 330 whether the user is included in a holdout group for the selected candidate advertisement. Users included in the holdout group are users eligible to be presented with the selected candidate advertisement but who are not presented with the selected candidate advertisement. The DSP 140 uses information associated with the selected candidate advertisement and information associated with the user included in the request to determine 330 whether the user is included in the holdout group for the selected candidate advertisement. In some embodiments, the DSP 140 applies a function, such as a hash function, to information identifying the user included in the received request compares the result of the function to values previously determined by the DSP 140, by the entity providing the selected candidate advertisement to the DSP 140, by the online system 130, or by any suitable entity that identify users included in the holdout group; if application of the function to the information identifying the user results in a value matching a previously determined value, the DSP 140 determines 330 the user is in the holdout group for the selected candidate advertisement. If the DSP 140 determines 330 the user is not included in the holdout group of the selected candidate advertisement, the DSP 140 communicates information identifying the selected candidate advertisement and its bid amount to the online system 130, which determines whether to present the selected candidate advertisement to the user via the client device 110 based at least in part on the bid amount of the selected candidate advertisement, as further described above in conjunction with FIG. 2

In response to determining 330 the user is included in the holdout group for the selected candidate advertisement, the DSP 140 identifies 335 an alternative candidate advertisement, as the user being included in the holdout group prevents presentation of the selected candidate advertisement to the user. For example, the DSP 140 identifies 335 a candidate advertisement having a lower position in a ranking of candidate advertisements based on their associated bid amounts. As an example, the DSP 140 identifies 335 a candidate advertisement having a second highest position in the ranking of candidate advertisements as the alternative candidate advertisement. In other embodiments, the DSP 140 identifies 335 an advertisement having a lower bid amount (e.g., an advertisement having a second highest bid amount) than the bid amount of the selected candidate advertisement as the alternative candidate advertisement. When an alternative candidate advertisement is identified 335, the DSP also determines whether the alternative candidate advertisement is undergoing lift analysis and whether the user is in a holdout group for the alternative candidate advertisement if the alternative candidate advertisement is undergoing lift analysis. In response to determining the user is in the holdout group for the alternative candidate advertisement, the DSP identifies an additional candidate advertisement as described above.

The DSP 140 associates 340 the bid amount of the selected candidate advertisement with the alternative candidate advertisement instead of the bid amount of the alternative candidate advertisement and communicates 345 a response to the online system 130 identifying the alternative candidate advertisement and the bid amount of the selected candidate advertisement associated with the alternative candidate advertisement. In some embodiments, the response communicated 345 to the online system 140 may also include information identifying the selected candidate advertisement (e.g., an identifier associated with the selected candidate advertisement) and an indication the alternative candidate advertisement was identified because the selected candidate advertisement is undergoing lift analysis. This allows the DSP to mitigate one or more biases that may occur when performing lift analysis by ensuring that the holdout group for the selected candidate advertisement is representative of users who would have been presented with the selected candidate advertisement because users in the holdout group satisfy at least the threshold number of the targeting criteria associated with the selected candidate advertisement. In some embodiments, the DSP 140 modifies a tracking mechanism included in the alternative candidate advertisement that is identified by the response so that, when executed by the client device 110, the tracking mechanism causes the client device 110 to communicate information to the DSP 140 that the alternative candidate advertisement was presented because the user was in the holdout group for the selected candidate advertisement and that identifies the selected candidate advertisement. If the DSP 140 identifies an additional candidate advertisement because the user is in the holdout group for the alternative candidate advertisement, the DSP 140 associates 340 the bid amount of the selected candidate advertisement with the additional candidate advertisement and communicates 345 a response identifying the additional candidate advertisement and the bid amount of the selected candidate advertisement to the online system 130.

Additionally, associating 340 the bid amount of the selected candidate advertisement with the alternative candidate advertisement does not artificially decrease the bid amount provided to the online system 130, so the lift analysis does not decrease potential revenue to the online system 130. Allowing the online system 130 to use the bid amount for the selected candidate advertisement when evaluating the alternative candidate advertisement prevents the percentage of opportunities for presenting advertisements to users in the holdout group for the selected candidate advertisement in which an advertisement is presented to the users from being decreased lower than the percentage of opportunities for presenting advertisements to users not in the holdout group for the selected candidate advertisement in which an advertisement is presented to the users. Further, as users in the holdout group for the selected candidate advertisement have characteristics that also satisfy at least a threshold number of targeting criteria of the alternative candidate advertisement, a likelihood of similarity between the selected candidate advertisement and the alternative candidate advertisement is increased. Mitigating biases when performing lift analysis increases the likelihood of the lift analysis accurately describing effectiveness of the selected candidate advertisement.

Based on the bid amount associated with the alternative candidate advertisement in the response and bid amounts associated with other advertisements received from the DSP 140 or from other sources, the online system 130 selects an advertisement for presentation with the content. If the online system 130 selects the alternative candidate advertisement, the online system 140 includes information identifying the alternative candidate advertisement (e.g., a link to the alternative candidate advertisement) in content communicated to the client device 110 for presentation.

As described above in conjunction with FIG. 2, the DSP 140 may receive information from the client device 110 if the alternative candidate advertisement is presented by the client device 110 via a tracking mechanism included in the alternative candidate advertisement. For example, interactions with the alternative candidate advertisement or other interactions by the user with the client device 110 are communicated to the DSP 140 when the client device 110 executes the tracking mechanism. In some embodiments, the tracking mechanism includes information identifying the candidate advertisement (e.g., an identifier associated with the candidate advertisement by the DSP 140) along with the information describing the interactions with the alternative candidate advertisement. Including information identifying the candidate advertisement along with the information describing interactions with the alternative candidate advertisement allows the DSP 140 to maintain information describing possible interactions with the candidate advertisement if it were presented. The DSP 140 may also receive information describing interactions by the user from other sources, such as from an entity (e.g., an advertiser) associated with the alternative candidate advertisement. Based on actions performed by various users and presentation of advertisements to users, the DSP 140 determines an effectiveness of presentation of an advertisement to users in causing the users to perform various actions. In some embodiments, the DSP 140 determines a contribution of presentation of an advertisement to users performing an action based on one or more attribution models. For example, an attribution model identifies an advertisement most recently presented to a user as a cause for the user performing a particular action associated with the advertisement; such a model would indicate that a user included in the holdout group for the advertisement performed the particular action associated with the advertisement without presentation of the advertisement to the user. Application of the one or more attribution models allows the DSP 140 to determine rates at which presentation of an advertisement to users is followed by the user performing an action as well as at which presentation of another advertisement is followed by the user performing the action. A ratio of these two rates may allow an entity to determine an effectiveness of the advertisement in causing users to perform the action.

### Determining Payment for Lift Analysis of an Advertisement

When performing lift analysis on an advertisement, the DSP 140 may determine an amount to charge an entity associated with the advertisement that differs from an amount charged to the entity when lift analysis is not performed. For example, if a selected advertisement is not communicated to an online system 130 to be evaluated for presentation to a user because the user is in a holdout group for the advertisement and an alternative advertisement communicated to the online system 130 along with a bid amount for the selected advertisement is selected by the online system 130 (which notifies the DSP 140 that the alternative advertisement was selected), the DSP 140 determines a difference between the bid amount for the selected advertisement and a bid amount for the alternative advertisement. The DSP 140 then charges an entity associated with the selected advertisement the difference. Alternatively, the DSP 140 charges the entity associated with the selected advertisement and the entity associated with the alternative advertisement different portions of the bid amount for the selected advertisement if the alternative advertisement is selected for presentation by the online system 130. For example, the entity associated with the selected advertisement and the entity associated with the alternative advertisement each pay 50% of the bid amount for the selected advertisement. In other embodiments, the DSP 140 charges the entity associated with the alternative advertisement the bid amount for the alternative advertisement and an entity associated with the DSP 140, or the DSP 140, provides the difference between the bid amount for the alternative advertisement and the bid amount for the selected advertisement.

The online system 130 may provide the DSP 140 with an amount to charge an entity associated with an advertisement provided to the online system 130 by the DSP 140 and selected for presentation by the online system 130. The DSP 140 may use the amount provided by the online system 130 to determine amounts to charge one or more advertisers. For example, the online system 130 charges an entity associated with an advertisement selected by the online system 130 an amount based on bid amounts of advertisements not selected by the online system 130 (e.g., a bid amount of an advertisement not selected by the online system 130 having a lower bid amount than the advertisement selected by the online system 130). The amount the online system 130 charges the entity associated with the advertisement selected by the online system 130 may be less than or equal to the bid amount of an alternative advertisement provided to the online system 130 by the DSP 140 if an advertisement selected by the DSP 140 is unable to be presented to a user. In this example, if the alternative advertisement is selected by the online system 130, the DSP 140 charges an entity associated with the alternative advertisement the amount charged by the online system 130 and does not charge an additional entity a difference between the bid amount for the alternative advertisement and a bid amount for the advertisement selected by the DSP 140.

In some embodiments, the DSP 140 computes a total cost to an entity associated with an advertisement undergoing lift analysis. During the lift analysis of the advertisement, the entity may provide compensation when the advertisement is not presented to users in a holdout group for the advertisement. Hence, the total cost to the entity accounts for resources expended by the DSP 140 to perform the lift analysis in addition for resources used when presenting the advertisement. Hence, the cost for performing the lift analysis may be separately assessed to the entity or may be factored into amounts charged to the entity when the advertisement, or other advertisements associated with the entity, are presented.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
maintaining a plurality of advertisements, each advertisement including targeting criteria identifying characteristics of users eligible to be presented with an advertisement and bid information specifying an amount of compensation from an entity associated with the advertisement in exchange for presentation of the advertisement;
receiving a request for one or more advertisements for presentation to a user from an online system, the request including information associated with the user to be presented with the one or more advertisements;
selecting one or more candidate advertisements from the maintained plurality advertisements, each candidate advertisement including at least a threshold number of targeting criteria satisfied by the information associated with the user;
computing bid amounts for each of the candidate advertisements, a bid amount for a candidate advertisement based at least in part on bid information associated with the candidate advertisement and targeting criteria included in the candidate advertisement satisfied by the information associated with the user;
selecting a candidate advertisement based at least in part on the computed bid amounts;
determining that the selected candidate advertisement is undergoing lift analysis to determine an effectiveness of the selected candidate advertisement;
determining that the user is part of a holdout group for the selected candidate advertisement, the holdout group identifying users to whom the selected candidate advertisement is not shown;
identifying an alternative candidate advertisement based at least in part on the computed bid amounts; and
communicating a response to the online system including the alternative candidate advertisement in association with the bid amount for the selected candidate advertisement to the online system.

2. The method of claim 1, wherein the selected candidate advertisement comprises a candidate advertisement having a highest bid amount, and wherein identifying the alternative candidate advertisement based at least in part on the computed bid amounts comprises:
identifying the alternative candidate advertisement as a candidate advertisement having a second highest bid amount.

3. The method of claim 1, further comprising:
determining a difference between the bid amount of the selected candidate advertisement and a bid amount of the alternative candidate advertisement in response to receiving an indication the alternative candidate advertisement was selected for presentation to the user;
charging the bid amount of the alternative candidate advertisement to an entity associated with the alternative candidate advertisement; and
charging an entity associated with the selected candidate advertisement the determined difference.

4. The method of claim 1, further comprising:
charging the bid amount of the selected candidate advertisement in part to an entity associated with the selected candidate advertisement and in part to an entity associated with the alternative candidate advertisement in response to receiving an indication the alternative candidate advertisement was selected for presentation to the user.

5. The method of claim 1, further comprising:
charging the bid amount of the alternative candidate advertisement to an entity associated with the alternative candidate advertisement in response to receiving an indication the alternative candidate advertisement was selected for presentation to the user.

6. The method of claim 1, wherein identifying the alternative candidate advertisement based at least in part on the computed bid amounts comprises:
determining the alternative candidate advertisement is undergoing lift analysis to determine an effectiveness of the alternative candidate advertisement;
determining that the user is part of a holdout group for the alternative candidate advertisement, the holdout group identifying users to whom the alternative candidate advertisement is not shown; and
identifying an additional candidate advertisement based at least in part on the determined bid amounts.

7. The method of claim 6, wherein communicating the response to the online system including the alternative candidate advertisement in association with the bid amount for the selected candidate advertisement to the online system comprises:
communicating a response to the online system including the additional candidate advertisement in association with the bid amount for the selected candidate advertisement to the online system.

8. The method of claim 6, wherein identifying the additional candidate advertisement based at least in part on the determined bid amounts comprises:
identifying a candidate advertisement having a bid amount lower than a bid amount for the alternative candidate advertisement as the additional candidate advertisement.

9. The method of claim 1, wherein the alternative candidate advertisement includes a tracking mechanism that, when executed by a client device presenting the alternative candidate advertisement, communicates information describing one or more interactions with the alternative candidate advertisement from the client device and identifying the selected candidate advertisement.

10. The method of claim 1, wherein an entity associated with the selected candidate advertisement identifies a size of the holdout group for the selected candidate advertisement.

11. A computer program product comprising a computer readable storage medium having instructions encoded thereon that, when executed by a processor, cause the processor to:
maintain a plurality of advertisements, each advertisement including targeting criteria identifying characteristics of users eligible to be presented with an advertisement and bid information specifying an amount of compensation from an entity associated with the advertisement in exchange for presentation of the advertisement;
receive a request for one or more advertisements for presentation to a user from an online system, the request including information associated with the user to be presented with the one or more advertisements;
select one or more candidate advertisements from the maintained plurality advertisements, each candidate advertisement including at least a threshold number of targeting criteria satisfied by the information associated with the user;
compute bid amounts for each of the candidate advertisements, a bid amount for a candidate advertisement based at least in part on bid information associated with the candidate advertisement and targeting criteria included in the candidate advertisement satisfied by the information associated with the user;
select a candidate advertisement based at least in part on the computed bid amounts;
determine that the selected candidate advertisement is undergoing lift analysis to determine an effectiveness of the selected candidate advertisement;
determine that the user is part of a holdout group for the selected candidate advertisement, the holdout group identifying users to whom the selected candidate advertisement is not shown;
identify an alternative candidate advertisement based at least in part on the computed bid amounts; and
communicate a response to the online system including the alternative candidate advertisement in association with the bid amount for the selected candidate advertisement to the online system.

12. The computer program product of claim 11, wherein the selected candidate advertisement comprises a candidate advertisement having a highest bid amount, and wherein identify the alternative candidate advertisement based at least in part on the computed bid amounts comprises:
identify the alternative candidate advertisement as a candidate advertisement having a second highest bid amount.

13. The computer program product of claim 11, wherein the computer readable storage medium further has instructions encoded thereon that, when executed by the processor, cause the processor to:
determine a difference between the bid amount of the selected candidate advertisement and a bid amount of the alternative candidate advertisement in response to receiving an indication the alternative candidate advertisement was selected for presentation to the user;
charge the bid amount of the alternative candidate advertisement to an entity associated with the alternative candidate advertisement; and
charge an entity associated with the selected candidate advertisement the determined difference.

14. The computer program product of claim 11, wherein the computer readable storage medium further has instructions encoded thereon that, when executed by the processor, cause the processor to:
charge the bid amount of the selected candidate advertisement in part to an entity associated with the selected candidate advertisement and in part to an entity associated with the alternative candidate advertisement in response to receiving an indication the alternative candidate advertisement was selected for presentation to the user.

15. The computer program product of claim 11, wherein the computer readable storage medium further has instructions encoded thereon that, when executed by the processor, cause the processor to:
charge the bid amount of the alternative candidate advertisement to an entity associated with the alternative candidate advertisement in response to receiving an indication the alternative candidate advertisement was selected for presentation to the user.

16. The computer program product of claim 11, wherein identify the alternative candidate advertisement based at least in part on the computed bid amounts comprises:
determine the alternative candidate advertisement is undergoing lift analysis to determine an effectiveness of the alternative candidate advertisement;
determine that the user is part of a holdout group for the alternative candidate advertisement, the holdout group identifying users to whom the alternative candidate advertisement is not shown; and
identify an additional candidate advertisement based at least in part on the determined bid amounts.

17. The computer program product of claim 16, wherein communicate the response to the online system including the alternative candidate advertisement in association with the bid amount for the selected candidate advertisement to the online system comprises:
communicate a response to the online system including the additional candidate advertisement in association with the bid amount for the selected candidate advertisement to the online system.

18. The computer program product of claim 16, wherein identify the additional candidate advertisement based at least in part on the determined bid amounts comprises:
identify a candidate advertisement having a bid amount lower than a bid amount for the alternative candidate advertisement as the additional candidate advertisement.

19. The computer program product of claim 11, wherein the alternative candidate advertisement includes a tracking mechanism that, when executed by a client device presenting the alternative candidate advertisement, communicates information describing one or more interactions with the alternative candidate advertisement from the client device.

20. The computer program product of claim 11, wherein an entity associated with the selected candidate advertisement identifies a size of the holdout group for the selected candidate advertisement.
